(19) United States
(12) Patent Application Publication
(10) Pub. No.: US 2009/0283558 A1
(43) Pub. Date: Nov. 19, 2009

(54) MOUNTING A DEVICE TO AN ITEM OF HEADWEAR

(75) Inventor: Darrell Wanzer, Drummond, OK (US)

Correspondence Address: McCarthy Law Group, 5830 Northwest Expressway, # 353, OKLAHOMA CITY, OK, 73132, US

(73) Assignee: DSA Designs LLC, Drummond, OK (US)

(21) Appl. No.: 12/270,712

(22) Filed: Nov. 13, 2008

Related U.S. Application Data
(60) Provisional application No. 60/987,503, filed on Nov. 13, 2007.

(51) Int. Cl. A42B 1/24; F21V 21/084

(52) U.S. Cl. 224/181; 2/422; 29/428; 362/106

(57) ABSTRACT

An apparatus and associated method for mounting a device beneath the brim of a helmet. The apparatus defines a passageway that is sized to receivingly engage the device, and further defines an aperture pattern arranged to align with a preexisting threaded fastener pattern on the helmet to operably position the bracket beneath the brim not extending substantially beyond an outer edge of the brim. A flexible portion of the apparatus is selectively engageable to transmit a force to the flexible portion of the bracket to operably reduce the size of the passageway and thereby frictionally affix the bracket to the device.

### RELATED APPLICATIONS

This application claims the benefit of the earlier filing date of U.S. Provisional Application No. 60/987,503.

### FIELD

The present embodiments pertain generally to the field of headwear and more particularly but not by way of limitation to an apparatus and associated method for removably attaching an auxiliary device to an item of headwear.

### BACKGROUND

In many circumstances, and for various different reasons, it is desirable to mount an illuminating device such as a flashlight to an item of headwear. Recreational circumstances, for example, include hunters who walk through wooded areas during the dark and need their hands free to carry a rifle and other gear. Bicycle riders are another example where the user might need to operate a flashlight in a manner such that her hands are free to control the bicycle. Occupational circumstances, for example, include miners who work in otherwise very dark places and need their hands freed up to operate tools. Firefighters as well often need the benefit of a light while needing both hands for fighting a fire and performing rescue operations in areas where visibility is impaired by darkness and/or smoke.

In all these circumstances it is advantageous to mount the flashlight to an item of headware so that the beam of light can be directed in the user's line of sight. Furthermore, by rigidly affixing the flashlight to the item of headwear so that the two move in unison, the user is able to direct the beam of light specifically to where he needs to see entirely by the respective movement of his head without the need for hand adjustment. Especially in the latter example of the firefighter, that rigid attachment must be adequate to keep the flashlight trained in the desired position even though it is likely to be impacted when the firefighter bumps into structure or by falling debris existing at the place where a rescue operation is happening. Also particularly advantageous in the latter example of the firefighter would be if the flashlight could be mounted in a manner so as to be entirely tucked inside the outer edge of the brim of the firefighter's helmet to prevent it from becoming entangled on the structure, or damaged by the falling debris and water.

Firefighter's helmets are lifesaving devices made to stringent specifications in order to provide the utmost safety to the men and women who enter into dangerous conditions to perform these rescue operations. Modifying a firefighter's helmet by physically altering it in order to mount a flashlight must be done at the risk of doing so without the manufacturer's permission. The manufacturer generally prohibits such modifications because it is impossible to foresee all the ways someone might drill holes and/or cut slots into a helmet in order to attach a light. Any such physical modification alters the mechanical strength and reliability of the helmet to endure the harsh conditions it is designed to withstand.

For these reasons the previously attempted solutions leave an unresolved need for improvements to the manner in which a flashlight can be mounted to an item of headwear and operated hands free. It is to these and other improvements that the embodiments of the present invention are generally directed.

### SUMMARY

Embodiments of the present invention are generally directed to an apparatus and associated method for attaching an auxiliary device to an item of headwear.

In some embodiments a bracket is provided that mounts a device beneath the brim of a helmet. The bracket defines a passageway that is sized to receivingly engage the device, and further defines an aperture pattern arranged to align with a preexisting threaded fastener pattern on the helmet to operably position the bracket beneath the brim not extending substantially beyond an outer edge of the brim. A flexible portion of the bracket is selectively engageable with a fastener that transmits a force, created by advancing the fastener, to the flexible portion of the bracket to operably reduce the size of the passageway and thereby frictionally affix the bracket to the device.

In some embodiments a bracket is provided for mounting a device beneath the brim of a helmet. The bracket defines a passageway that is sized to receivingly engage the device. The bracket defines a first attachment feature configured to attach the bracket to a preexisting attachment feature of the helmet so that the bracket is operably positioned entirely beneath the brim not extending substantially beyond an outer edge of the brim. The bracket further defines a second attachment feature configured to selectively reduce the size of the passageway and thereby frictionally affix the bracket to the device.

In some embodiments a method is provided for attaching a device beneath the brim of a helmet, including steps of: removing a plurality of fasteners from the helmet that are operably arranged in a fastener pattern; obtaining a bracket that defines a passageway for receivingly engaging the device and defines an aperture pattern configured to operably align with the fastener pattern where the bracket is disposed entirely beneath the brim not extending substantially beyond an outer edge of the brim; aligning the aperture pattern with the fastener pattern; affixing the bracket to the helmet by replacing fasteners to the fastener pattern; and affixing the device to the bracket.

These and various other features and advantages which characterize the embodiments of the claimed invention will become apparent upon reading the following detailed description and upon reviewing the associated drawings.

### BRIEF DESCRIPTION OF THE DRAWINGS

FIG. 1 depicts a side elevational view of a helmet outfitted with a flashlight in accordance with embodiments of the present invention.

FIG. 2 depicts a front elevational view of another helmet outfitted with a flashlight in accordance with embodiments of the present invention.

FIG. 3 diagrammatically depicts an exploded isometric view of the outfitted helmet of FIG. 2.

FIG. 4 depicts an isometric view of the flashlight mounting bracket of FIG. 1.

FIG. 5 depicts an isometric view of the flashlight operably disposed in the bracket of FIG. 4.

FIGS. 6 and 7 depict end and top views, respectively, of a bracket constructed in accordance with alternative embodiments of the present invention.

FIG. 8 depicts a view similar to FIG. 7 of a bracket constructed in accordance with alternative embodiments of the present invention.

### DETAILED DESCRIPTION

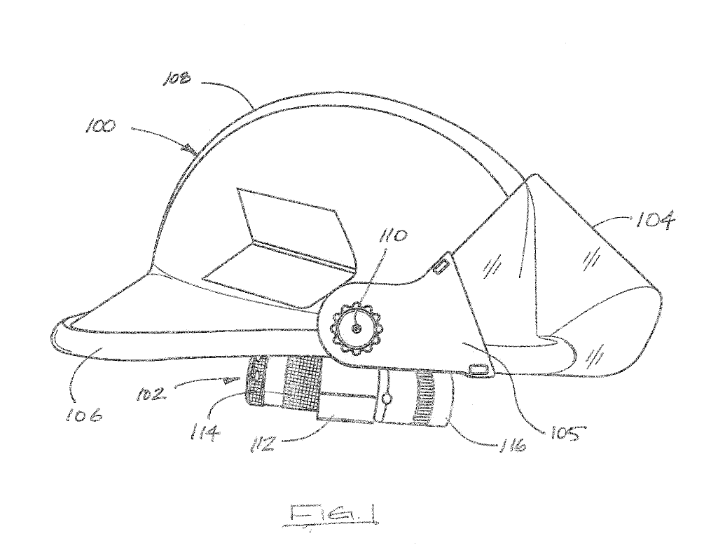

Turning to the FIGS, generally and particularly now to FIG. 1 which depicts a side elevational view of a firefighter's helmet 100 that is outfitted with a flashlight 102 in accordance with embodiments of the present invention. The skilled artisan will recognize the helmet 100 is of a characteristic construction that is generally referred to as a “modern style” of firefighter's helmet. The helmet depicted in FIG. 1 has a face shield 104 supported by a bracket 105 that is mounted to the underside of opposing sides of a brim 106 projecting outwardly from a dome 108 that receivingly engages the user's head. The bracket 105 provides a swivel action around an axis of rotation 110 (coming out of the page in FIG. 1) so that the face shield 104 is selectively positionable between a lowered position to protect the user and a raised position as depicted in FIG. 1. Although not depicted, this modern style of helmet 100 typically also has a chin strap mounted to the underside of the brim 106 for securing the helmet 100 to the user's head.

The flashlight 102 is likewise attached to the underside of the brim 106 by a bracket 112 that is constructed in accordance with embodiments of the present invention. The bracket 112 is sized to clampingly affix to a longitudinal elongated handle 114 of the flashlight 102. The clamping engagement and the placement of the flashlight 102 under the brim 106 do not encumber the movement of a selectively rotatable focusing member 116 that allows the user to set a desired intensity of the beam of light delivered by the flashlight 102.

As seen in the FIGS, that follow, the bracket 112 has an aperture pattern that is arranged to align with a preexisting threaded fastener pattern provided on the helmet 100 that is used to attach the face shield bracket 105. This permits readily attaching the bracket 112 to the helmet 100 without physically altering the construction of the helmet 120, by using a preexisting fastener pattern. Also, as better depicted in the FIGS. that follow, the bracket 112 is sized and configured so that the flashlight 102 is operably positioned entirely beneath the brim 106 and thereby within an outermost edge of the brim 106. This arrangement protects the flashlight 102 from being damaged or dislodged by becoming entangled with structure or by falling debris and water that are present at the place where the user is wearing the helmet 100.

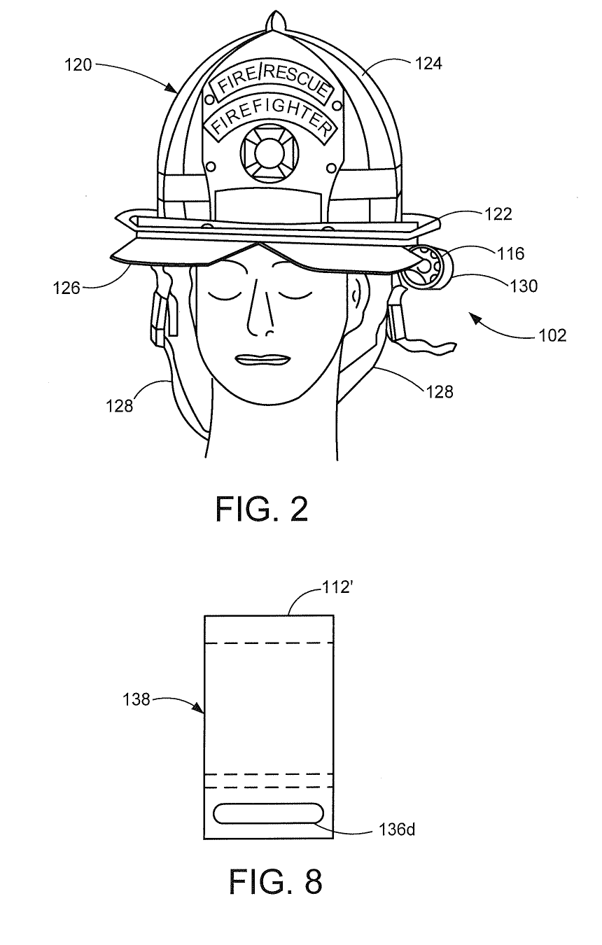

FIG. 2 depicts a front elevational view of another helmet 120 outfitted with the flashlight 102 in accordance with embodiments of the present invention. The skilled artisan will recognize the helmet 120 is of a characteristic construction that is generally referred to as a “traditional style” of firefighter's helmet. Similar to FIG. 1, the helmet 120 has a brim 122 extending outwardly around the periphery of a dome 124. A face shield 126 is pivotally mounted to the underside of the brim 122. A chin strap 123 is also attached at distal ends to the underside of the brim 122. The chin strap 128 depicted in FIG. 2 is positioned behind the user's neck instead of under his chin and loosely fitting solely for clarity sake in illustrating the salient features of the claimed embodiments.

In these embodiments the flashlight 102 is mounted via a bracket 130 that has an aperture pattern arranged to align with the preexisting threaded fastener pattern provided on the helmet 120 that is used to attach one end of the chin strap 128. As above, this permits readily attaching the bracket 130 to the helmet 120 without physically altering the construction of the helmet 120, by using a preexisting fastener pattern. Also, as mentioned above, the brackets 112, 130 are sized and configured so that the flashlight 102 is operably positioned entirely beneath the respective brim 106, 122 and thereby within an outermost edge of the brim 106. Again, that mounting arrangement prevents the flashlight 102 from becoming entangled on structure through which the user is passing, and protects the flashlight 102 from being dislodged or damaged by being impacted by the structure or by falling debris and water.

FIG. 3 diagrammatically depicts a simplified exploded isometric view of the helmet 120 (FIG. 2) operably outfitted with the flashlight 102 in accordance with the present embodiments. A chin strap mounting bracket 132 defines a preexisting threaded fastener pattern 134 that is used to attach it to the brim 122. In the illustrative embodiments depicted in FIG. 3 the fastener pattern 134 includes two apertures, but the contemplated embodiments of the present invention are not so limited. Generally, the fastener pattern 134 provides a preexisting fastener pattern from the manufacturer that utilizes removable fasteners for attaching the chin strap 128 to the helmet 120. In some circumstances, for example, the fastener pattern 134 can be clearance holes through which threaded members pass and threadingly engage either a threaded insert in the brim 122 or a backing nut on the top side of the brim 122. Alternatively, the fastener pattern 134 can be threaded apertures or threaded posts.

In any event, the bracket 130 defines an aperture pattern 136 that is arranged to align with the preexisting threaded fastener pattern 134 to operably position the bracket 130 beneath the brim 122 not extending substantially beyond an outer edge of the brim 122, as depicted in FIG. 2 and for the reasons described above. In the illustrative embodiments of FIG. 3 a like number of fasteners 137 pass through the aperture pattern 136 and threadingly engage the threaded fastener pattern 134 to affix the bracket 130 beneath the brim 122. For example, without limitation, the fasteners 137 can pass through clearance holes 134, 136 and threadingly engage respective threaded inserts or backing nuts supported by the brim 122.

The bracket 130 defines a passageway 138 that is sized to receivingly engage the elongated handle 114 in somewhat of a close mating relationship. The bracket 130 also defines a slot 140 coextensive with at least a portion of the passageway 138 to create flexible portions 142, 144 of the bracket 130 on opposing sides of the slot 140. A fastener 146 is selectively engageable with the flexible portions 142, 144 to create a force, by advancing the fastener 146, to the bracket 130 to operably reduce the size of the passageway 138 and thereby frictionally affix the bracket 130 to the flashlight 102.

For example, without limitation, the bracket 130 can define a clearance aperture 148 extending through the flexible portion 142 and aligned with a threaded aperture (not shown) in the other flexible portion 144. Thus, threadingly advancing the fastener 146 reduces the width of the slot 140 between the flexible portions 142, 144 and, in turn, reduces the cross sectional size of the passageway 138. The fastener 146 can be advanced to a position whereby the reduced size of the passageway 138 frictionally engages the elongated handle 114 so as to rigidly affix the flashlight 102 to the bracket 130.

FIGS. 4 and 5 depict isometric views of the bracket 112 of FIG. 1 used to mount the flashlight 102 in a somewhat different manner than the bracket 130 (FIG. 3) within equivalent alternative embodiments of the present invention. Like the bracket 130, the bracket 112 defines a slot 148 intersecting the passageway 138. Also like the bracket 130, aperture pattern 136 is sized and arranged for admitting a plurality of fasteners 137 to attach the bracket 112 beneath the brim 106. However, unlike the bracket 130, the aperture pattern 136 also intersects the slot 148. Thus, advancing the fasteners 137 to attach the bracket 112 to the brim 106 also eventually displaces the flexible portions 142, 144 of the bracket 112 to reduce a nominal size of the slot 148 and, in turn, reduce the size of the passageway 138 to effect a frictional attachment to the flashlight 102.

FIGS. 6 and 7 depict end and top views, respectively, of a bracket 112′ constructed to include additional features in accordance with equivalent alternative embodiments of the present invention. Although depicted by a comparison to the bracket 112, the skilled artisan readily recognizes that these additional features can likewise be present in equivalent alternative embodiments of the bracket 130 and other such brackets contemplated within the scope of the claimed embodiments. The views depicted in FIGS. 6 and 7 are also used in the following to describe features of the brackets 112, 130 that are more readily ascertainable here.

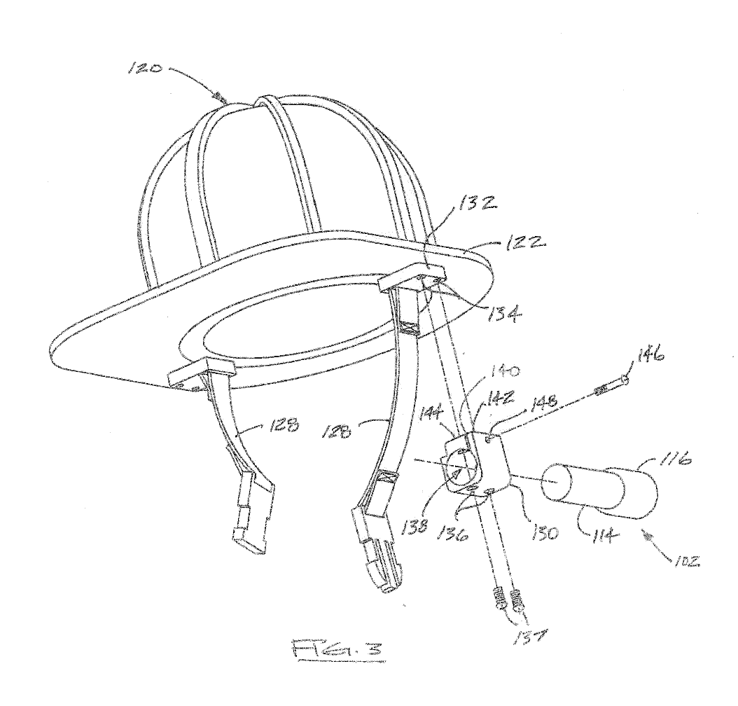

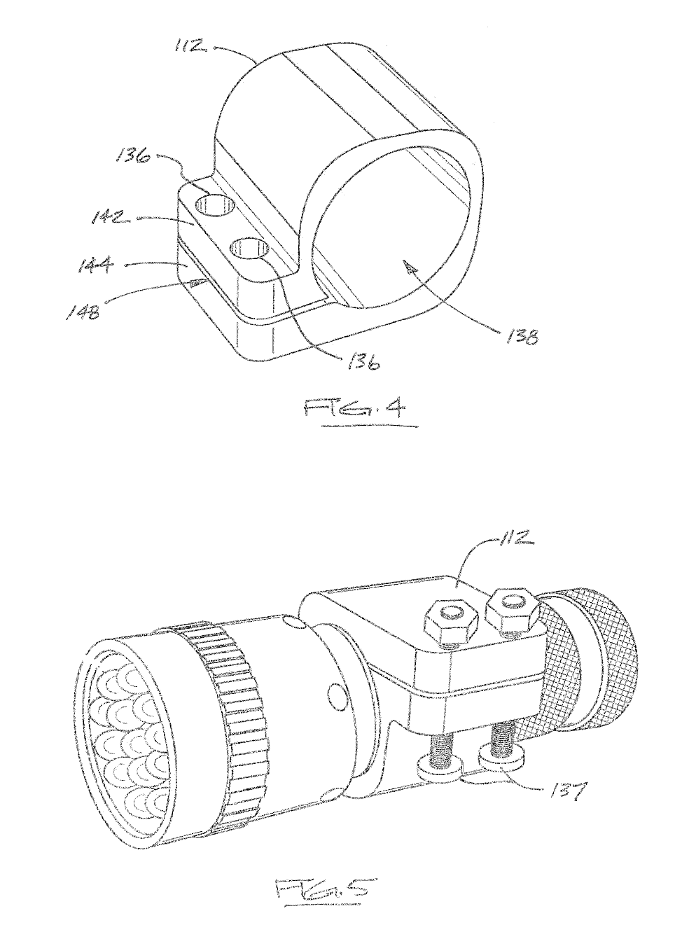

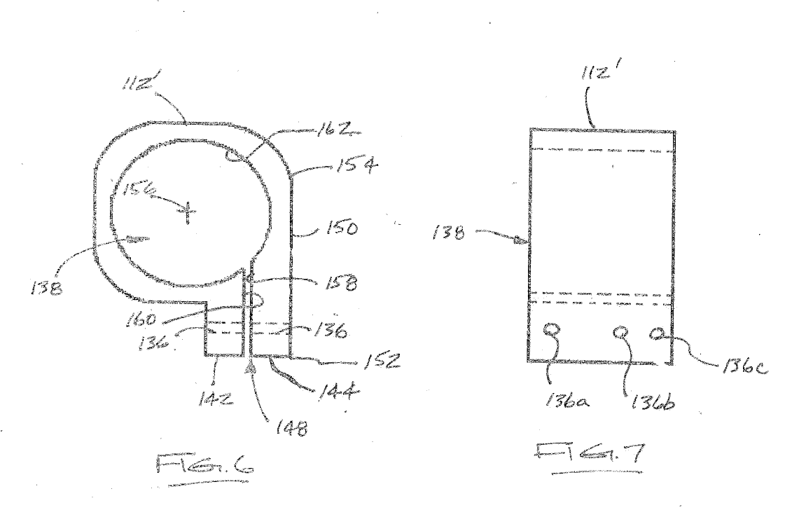

In the foregoing illustrative examples the aperture pattern 136 accommodates two fasteners 137, although the number of fasteners 137 is determined by the preexisting fastener pattern 134. The bracket 112′ here depicts an aperture pattern having three apertures 136a, 136b, 136c. In these illustrative embodiments a first portion of the aperture pattern, such as 136a, 136b, is operably alignable with a first preexisting threaded fastener pattern 134, and a second portion of the aperture pattern, such as 136a, 136c, is operably alignable with a different second preexisting threaded fastener pattern 134. This construction provides a multiple use bracket 112′ that has one set of mounting holes say for mounting to the fastener pattern of the chin strap and a different set of mounting holes say for mounting to the fastener pattern of the face shield. Also, the arrangements of the fastener pattern 134 can vary from one manufacturer to another, so the multiple use bracket 112′ provides a generic bracket that is adapted to different helmet brands. FIG. 8 depicts a view similar to FIG. 7 but having an elongated slot 136d that can accommodate one or more fasteners 137 anywhere therealong.

FIG. 6 also best depicts features of the claimed embodiments that provide the necessary structural integrity in mounting the flashlight 102 for the intended use. The bracket 112′ defines a contact surface 150 that is characteristically shaped to operably contactingly engage the underside of the brim 106 in a close mating relationship. For example, the substantially planar surface 150 extending between a proximal end 152 and a distal end 154 preferably corresponds to a mating planar surface formed on the underside of the brim 106. Alternatively, if the underside of the brim 106 formed an arcuate surface then the contact surface 150 preferably would form a mating arcuate surface. This mating relationship of contacting surfaces provides a solid contacting engagement of the bracket 112′ to the brim 106.

Note also that the extent of the contact surface 150 spans opposing sides of a longitudinal axis 156 of the passageway 138. That is, the proximal end 152 of the contact surface 150 is disposed on one side of the longitudinal axis 156 (below in FIG. 6), whereas the distal end 154 of the contact surface 150 is disposed on the other side of the longitudinal axis 156 (above in FIG. 6). Spreading the attachment force to this extent on opposing sides of the longitudinal axis 156 further serves to increase the integrity with which the bracket 112′ secures the flashlight 102.

It will also be noted that the unitary construction of the bracket 112′ further enhances the structural integrity of the claimed embodiments by eliminating joints and joining methods necessary in assemblies. By unitarily constructing the bracket 112′, such as of a polymer or metal, cross-sectional thicknesses between the passageway 138 and external surfaces can be made nonuniform as needed to add necessary strength where necessary while yet providing the necessary flexibility.

FIG. 6 also shows how preferably the opposing surfaces 158, 160 defining the slot 148 are substantially parallel. This construction maximizes the peripheral contacting engagement between an arcuate surface 162 (defining the passageway 138) and the elongated handle 114 of the flashlight 102. In the illustrative embodiments the surface 162 defines a cylindrical bore that operably contacts the elongated handle 114 along an entire cross-sectional peripheral engagement except where the slot 148 intersects the passageway 138.

FIG. 6 further illustrates preferred embodiments whereby the slot 148 and the longitudinal axis 156 are noncoplanar. This permits advancing the fasteners 137 to a loose engagement whereat the contact surface 150 matingly engages the brim 106 but the flashlight 102 is still slidingly engageable in the passageway 138. This facilitates the user being able to position the flashlight 102 precisely where she wants it, and then further tightening the fasteners 137 to deflect the flexible portion 142 with respect to the other flexible portion 144 to affix the flashlight 102 without it moving from the desired position.

Generally, from the foregoing the skilled artisan will recognize that the claimed embodiments contemplate a bracket for mounting a device beneath the brim of a helmet. In the illustrative embodiments the device is a flashlight but the contemplated embodiments are not so limited. For example, in alternative equivalent embodiments other types of devices can be mounted in like manner such as, but not limited to, a camera and an environment monitoring device. The skilled artisan will likewise recognize that typically two devices can be mounted to the helmet because the preexisting fastener patterns mount two sides of the chin strap and face shield in a similar manner. That is, the entire description of FIG. 3 above is applicable to attaching the auxiliary device to the other end of the chin strap 128 or attaching two auxiliary devices in like manner as well.

The bracket defines a passageway that is sized to receivingly engage the device. The bracket further defines a first attachment feature, such as the aperture pattern, configured to attach the bracket to a preexisting attachment feature of the helmet so that the bracket is operably positioned entirely beneath the brim not extending substantially beyond an outer edge of the brim. The bracket further defines a second attachment feature, such as one or more flexible portions configured to selectively reduce the size of the passageway and thereby frictionally affix the bracket to the device.

The disclosed structure and equivalent embodiments thereof enable the user to practice a method for attaching the device to the brim of a helmet The method includes the step of removing a plurality of fasteners from the helmet that are operably arranged in a fastener pattern, such as in the illustrative embodiments that attach the chin strap or the face shield to the helmet. According to the method the user then obtains the disclosed bracket defining the passageway for receivingly engaging the device and defining an aperture pattern configured to operably align with the fastener pattern so that the bracket is operably disposed entirely beneath the brim not extending substantially beyond an outer edge of the brim. The user then aligns the aperture pattern with the fastener pattern, and affixes the bracket to the helmet by replacing fasteners to the fastener pattern. The replacing fasteners may require the use of relatively longer fasteners. Finally, the user affixes the device to the bracket either by further advancing the same or other fasteners.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the devices in which they are incorporated or the particular environment in which they are used without departing from the spirit and scope of the present invention.

In addition, although the illustrative embodiments described herein are directed to a helmet, it will be appreciated by those skilled in the art that the claimed subject matter is not so limited and various other types of apparel can utilize the embodiments of the present invention without departing from the spirit and scope of the claimed invention.

What is claimed is:

1. A bracket that mounts a device beneath the brim of a helmet, the bracket defining a passageway that is sized to receivingly engage the device, the bracket further defining an aperture pattern arranged to align with a preexisting threaded fastener pattern on the helmet to operably position the bracket beneath the brim not extending substantially beyond an outer edge of the brim, and the bracket further defining a flexible portion that is selectively engageable with a fastener that transmits a force, created by advancing the fastener, to the flexible portion of the bracket to operably reduce the size of the passageway and thereby frictionally affix the bracket to the device.

2. The bracket of claim 1 wherein a first portion of the aperture pattern is operably alignable with a first preexisting threaded fastener pattern and a second portion of the aperture pattern is operably alignable with a different second preexisting threaded fastener pattern.

3. The bracket of claim 1 characterized by being unitarily constructed.

4. The bracket of claim 1 wherein the aperture pattern comprises an elongated slot.

5. The bracket of claim 1 wherein the bracket defines a contact surface that is characteristically shaped to operably contactingly engage the helmet in a close mating relationship, and wherein a proximal end of the contact surface is disposed on one side of a longitudinal axis of the passageway and a distal end of the contact surface is disposed on an opposing side of the longitudinal axis of the passageway.

6. The bracket of claim 1 wherein a cross-sectional thickness of the bracket between a surface defining the passageway and an external surface of the bracket is nonuniform.

7. The bracket of claim 1 defining a slot intersecting the passageway, wherein an aperture intersects the slot for admitting the fastener, and wherein the advancing the fastener displaces the flexible portion of the bracket to reduce a nominal size of the slot.

8. The bracket of claim 7 wherein the aperture pattern comprises the aperture intersecting the slot.

9. The bracket of claim 8 wherein the bracket defines a plurality of apertures intersecting the slot for admitting a like plurality of fasteners.

10. The bracket of claim 9 wherein a first portion of the plurality of apertures is operably alienable with a first preexisting threaded fastener pattern and a second portion of the plurality of apertures is operably alignable with a different second preexisting threaded fastener pattern.

11. The bracket of claim 7 wherein opposing surfaces of the bracket that define the slot are substantially parallel, and wherein a surface of the bracket defining the passageway operably contacts the device along a cross-sectional peripheral engagement except where the slot intersects the passageway.

12. The bracket of claim 11 wherein the passageway is characterized as a cylindrical bore.

13. The bracket of claim 7 wherein the slot and a longitudinal axis of the passageway are noncoplanar.

14. A bracket for mounting a device beneath the brim of a helmet, the bracket defining a passageway that is sized to receivingly engage the device, the bracket further defining a first attachment feature configured to attach the bracket to a preexisting attachment feature of the helmet so that the bracket is operably positioned entirely beneath the brim not extending substantially beyond an outer edge of the brim, and the bracket further defining a second attachment feature configured to selectively reduce the size of the passageway and thereby frictionally affix the bracket to the device.

15. The bracket of claim 14 wherein the preexisting attachment feature of the helmet comprises a threaded fastener pattern and the first attachment feature comprises an aperture pattern arranged to operably align with the threaded fastener pattern.

16. The bracket of claim 15 wherein a first portion of the aperture pattern is operably alignable with a first preexisting threaded fastener pattern and a second portion of the aperture pattern is operably alignable with a different second preexisting threaded fastener pattern.

17. The bracket of claim 15 wherein the second attachment feature comprises a flexible portion of the bracket that is selectively responsive to a force created by advancing a fastener to operably reduce the size of the passageway and thereby frictionally affix the bracket to the device.

18. The bracket of claim 17 wherein the fastener operably threadingly engages the threaded fastener pattern of the helmet.

19. A method for attaching a device beneath the brim of a helmet, comprising:
removing a plurality of fasteners from the helmet that are operably arranged in a fastener pattern;
obtaining a bracket that defines a passageway for receivingly engaging the device and defines an aperture pattern configured to operably align with the fastener pattern where the bracket is disposed entirely beneath the brim not extending substantially beyond an outer edge of the brim;
aligning the aperture pattern with the fastener pattern; and
affixing the bracket to the helmet by replacing fasteners to the fastener pattern; and
affixing the device to the bracket.

20. The method of claim 19 wherein the obtaining step is characterized by a first portion of the aperture pattern being operably alignable with a first fastener pattern of a first helmet and a second portion of the aperture pattern being operably alignable with a different second fastener pattern of a second helmet.
